(19) United States
(12) Patent Application Publication
(10) Pub. No.: US 2012/0011539 A1
(43) Pub. Date: Jan. 12, 2012

(54) METHOD, SYSTEM AND APPARATUS FOR PROCESSING A BROADCAST TELEVISION SIGNAL

(76) Inventors: Paul Jason Rogers, Rossendale (GB); Jean-Paul Heron, Belfast (GB)

(21) Appl. No.: 13/140,423

(22) PCT Filed: Dec. 17, 2009
(86) PCT No.: PCT/GB2009/051731

§ 371 Date: Sep. 22, 2011

(30) Foreign Application Priority Data
Dec. 17, 2008 (GB) 0822980.9

(51) Int. Cl. H04N 7/167

(52) U.S. Cl. 725/31

(57) ABSTRACT

The present invention relates generally to a method, system and/or apparatus for processing a broadcast television signal transmitted over a broadcast medium. A method of processing a digital television ‘TV’ signal at a customer premises system comprises the steps of: receiving a digital TV signal over a digital TV broadcast medium; converting packet data comprising said received digital TV signal to internet protocol ‘IP’ data packets; and transmitting said IP data packets to a customer premises; IP device or IP network. A customer premises apparatus for processing a digital television ‘TV’ signal comprises: means for receiving a digital TV signal over a digital TV broadcast medium; processing means for converting packet data comprising said received digital TV signal to internet protocol ‘IP’ data packets; and means for transmitting said IP data packets to a customer IP device or IP network.

The present invention relates generally to a method, system and/or apparatus for processing a broadcast television signal transmitted over a broadcast medium. The invention particularly, but nor exclusively, preferably concerns the processing of a digital broadcast television signal at a customer premises end of the broadcast medium. The invention may further relate to maintaining security of an encrypted broadcast television signal once it is processed at said customer end of the broadcast medium. The invention may find particular application in securing broadcast television signals received at a customer's premises and transmitted to or between customer premises internet protocol ‘IP’ enabled apparatuses or systems, particularly where such apparatuses or systems are networked in a home IP network.

Television signals are broadcast over many forms of broadcast medium. Such broadcast media may comprise a physical medium such as a cable television network or a non-physical medium such as air or a combination of physical and non-physical media. In some examples, a user receives the broadcast television signal over a satellite television broadcast system whereby the user has a satellite antenna receiving device such as a satellite dish installed at their customer premises. The user will traditionally also have installed a receiving device such as a set top box for processing the received broadcast satellite television signal before it is outputted to a television receiver for viewing. In yet other traditional broadcast television scenarios, users may receive the broadcast television signal over the air at a conventional television antenna installed at their customer premises. Such antennas are typically capable of receiving both digital and analogue broadcast televisions signals, but in the case of a digital broadcast television signal, the user usually has a suitably adapted television receiver and/or a set top box for processing the digital television signal before it is provided to a television receiver for viewing.

One problem with broadcast television scenarios as mentioned above is that the broadcast television signal, once processed at the customer premises for viewing on a conventional television receiving device, is not compatible for viewing on IP enabled devices such as personal computers ‘PCs’, personal digital assistants ‘PDAs’ or the like. Many users would like this capability, i.e. to also view a received broadcast television signal on an IP enabled device rather than just on a traditional TV receiver.

One solution to this problem is commonly known as IPTV whereby a subscriber receives an encoded digital TV signal over an IP broadband connection between the digital TV signal provider and the subscriber's home premises. A number of technical solutions have been developed that deliver TV using bi-directional IP over a broadband network, sometimes integrated with a range of other IP functionality. However, this solution negates the use of legacy broadcast TV signal receiving systems or apparatuses at the subscriber's home premises. It also requires the installation of new systems and apparatus at the provider's premises, the cost of which cannot, under usual business models, be immediately and directly recouped from the subscriber. Furthermore, this solution is not directly applicable to more conventional or legacy broadcast television systems because this solution requires the television signal to be adapted to an IP format at the provider's premises and the IP format content addressed to the IP subscriber for transmission to the subscriber on their broadband IP connection.

Broadcasters often provide one or more services on a “pay-per-view” ‘PPV’, e.g. subscription, basis. A known approach to limiting service access to authorised PPV users only is to distribute a service encryption key to the authorised users by public key encryption. Subsequently, the service encryption key is used to send control words for the authorised users' descramblers in order to descramble (un-encrypt) the broadcast service. These services may, for example, be scrambled and descrambled as described by international Digital Video Broadcasting (DVB) or ATSC standards. The DVB scrambling algorithm is known as the “Common Scrambling Algorithm” (DVB-CSA) which conventionally requires specific hardware at the broadcaster (hereafter the head-end) and at the receiver (typically in the form of a set-top box). Therefore a further problem facing digital TV providers who broadcast their content to subscribers over conventional or legacy broadcast media such as over the air, cable or satellite networks is the need to maintain transmission of the content in a secure fashion to the point of use, i.e. the point of viewing. In a traditional broadcast TV signal environment where the subscriber receives an encrypted broadcast TV signal at his customer premises set top box, the set top box is configured to un-encrypt, i.e. descramble, the received encrypted broadcast TV signal before transmitting the un-encrypted signal on an output to a TV receiver. In this way, the broadcast content is maintained in a secure fashion up to the point of viewing. However, where a subscriber wishes to also view the provided content on IP enabled devices, particularly where such devices are networked in a home IP network, a problem arises on how to maintain security of the content up to the point of viewing where such un-encrypted content is passed from the set top box to the IP enabled device(s) and/or IP home network.

The present invention seeks to obviate and/or mitigate problems associated with adapting digital broadcast TV signals received over a broadcast medium at a customer/subscriber's premises for use by customer premises IP enabled devices, systems, apparatuses or networks.

### GENERAL

According to one aspect of the invention, a method system and/or apparatus may be provided for processing a digital television ‘TV’ signal at a user's premises, the method comprising the steps of: receiving a digital TV signal over a digital TV broadcast medium such as cable, satellite or terrestrial broadcast networks; converting packet data comprising said received digital TV signal to internet protocol ‘IP’ data packets; and transmitting said IP data packets to a customer IP device and/or IP network.

Preferably this aspect of the invention results in no, or minimal investment being required by service providers who broadcast digital TV signals over a broadcast medium to enable end users to view the signals on IP devices. Furthermore, users/customers/subscribers of the service provider's broadcast system having conventional set top boxes for processing received the broadcast digital TV signal can continue to receive the conventional service whilst other users/customers/subscribers wishing to change or upgrade to an enhanced service can purchase suitable customer premises equipment for converting the received broadcast digital TV signal to a suitable IP packet data format for use by IP enabled devices. Thus, this aspect of the invention affords the provision of a versatile broadcast TV system which only requires some additional or replacement equipment at the customer premises' end of the broadcast TV signal medium.

According to a further aspect of the invention one or more parts of the received digital TV signal may be encrypted before the step of transmitting the IP data packets to a subscriber IP device or IP network.

Preferably this further aspect of the invention results in no, or minimal, investment is required by service providers who broadcast digital TV signals over a broadcast medium to enable end users to view the signals on IP devices.

According to a yet further aspect of the invention, where the digital TV signal received over the digital TV broadcast medium has been encrypted using a digital TV encryption algorithm, the received digital TV signal may be un-encrypted before it is converted.

This further aspect of the invention preferably allows subscribers to view scrambled digital TV services, such as “pay-per-view” services on their IP network devices.

### BRIEF DESCRIPTION OF DRAWINGS

Further aspects of the present invention will now be described, by way of example only, with reference to the following figures in which:

FIG. 1 is a functional block diagram showing an overview of a system for digital TV broadcasts in accordance with a first aspect of the present invention;

FIG. 2 is a functional block diagram showing an overview of a system for digital TV broadcasts in accordance with a second aspect of the present invention; and

FIG. 3 shows a distribution hub in accordance with a third aspect of the present invention.

### DESCRIPTION OF PREFERRED EMBODIMENTS

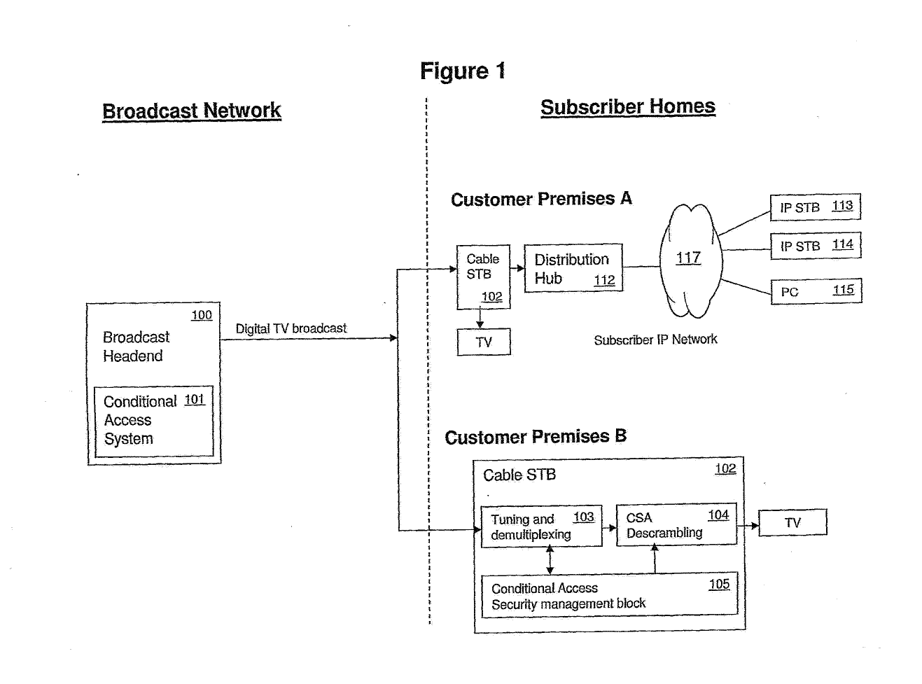

FIG. 1 gives an overview of the operation of a digital TV broadcasting system in accordance with a first embodiment of the present invention. The head-end broadcaster 100 transmits a digital TV signal which comprises one or more services using the standard DVB method, although it will be appreciated that the invention is not limited to only DVB based broadcast digital TV systems. Digital Video Broadcasting DVB' is a suite of open standards for digital television, which are maintained by the DVB Project. DVB broadcasting systems transmit data using a broadcast media, including by satellite (DVB-S, DVB-S2 and DVB-SH; also DVB-SMATV for distribution via SMATV); cable television (DVB-C); terrestrial television (DVB-T, DVB-T2) and digital terrestrial television for handhelds (DVB-H,DVB-SH); and via microwave using DTT (DVB-MT), the MMDS (DVB-MC), and/or MVDS standards (DVB-MS). The standards define the physical layer and data link layer of the distribution system. All data is transmitted in MPEG-2 transport streams with some additional constraints (DVB-MPEG).

At the receiving end, appropriate equipment such as a typical user's set top box 102 at customer premises B is used to receive the broadcasted signal which is decoded where appropriate and transmitted to a TV for viewing. Any user with appropriate equipment may receive the signals and, provided he has the appropriate equipment, may decode and view the services it comprises. In contrast, IPTV (Internet Protocol Television) is a system where a digital television service is delivered using Internet Protocol over an IP network infrastructure. IPTV is supplied by a small number of companies acting as service providers using a closed network infrastructure and IP multicast techniques. As such, IPTV requires that the service provider converts broadcast TV signals at the provider's headend prior to transmission of digital TV content to users over suitable broadband IP connections.

In this embodiment, the Conditional Access (CA) System 101 can be used to scramble one or more of the services using the “Common Scrambling Algorithm” DVB-CSA, so that only authorised users may decrypt and view the one or more services, e.g. pay-per-view services, on entitled devices. The DVB-CSA signal comprises MPEG PES packets split into chunks of 188 bytes. At the head-end broadcaster 100 a random code word is generated and this used to scramble up to 184 bytes of each chunk; the remainder of the chunk is the Transport Packet header which is not scrambled. Sixteen bytes of error correction information is added to the 188-byte MPEG Transport packets. The resulting 204-byte MPEG Transport packets are modulated and the resulting digital TV signal is broadcast by the head-end broadcaster 100. The codeword is encrypted using an Entitlement Key and the resulting Entitlement Control Message (ECM) is formed into an MPEG Transport packet or packets. The ECM is inserted into the signal 10 times every second. Typically the codeword is replaced by a new codeword every 10 seconds (this is known as the Crypto Period). The new ECM is formed and inserted every new crypto period. In other embodiments the crypto period and the rate at which ECMs are inserted into the signal may be differ.

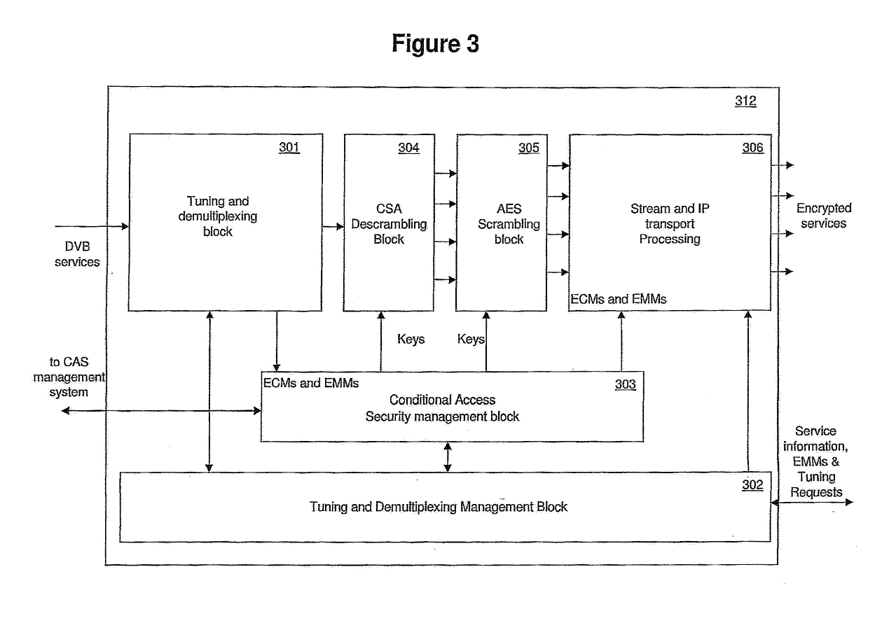

A typical user's set top box 102, such as the ones shown at Customer Premises A and Customer Premises B in FIG. 1, receives the transmitted DVB-CSA signal, and the tuning and demultiplexing unit 103 functions to select a service from the signal. If entitled to do so, the CA sub-system 105 decrypts the ECM corresponding to the service and passes the code word to the descrambling block 104. (For simplicity the CA sub-system 105 in FIG. 1 is shown as part of the set top box 102, but in most cases it will in part be on a smart card which is removably inserted into the set top box 102.) The descrambling block 104 uses the code word supplied by the CA sub-system 105 to descramble the user-selected service, provided the user is authorised to view the service, ready for transmission to a TV for viewing. Entitlement Management Messages (EMMs) are used to update the CA sub-system 105 with regard to which services the user is entitled to descramble. It will be clear that, with a prior-art system as described, if a user wishes to be able to access encrypted services through more than one TV independently respective set top boxes will be required for each TV. Furthermore, DVB-CSA signals are fundamentally incompatible with IP network devices due to the computational overhead of the algorithm in software and the impracticality of providing individual dedicated hardware units to respective network devices. In accordance with this embodiment of the invention, the distribution hub 112 at customer premises A can be connected to the standard set top box 102 in order to receive the digital TV services unmodified and convert them such that they can be communicated over the customer IP network 117. The way in which the services are communicated over the customer IP network 117 will be described in more detail below with reference to FIG. 3.

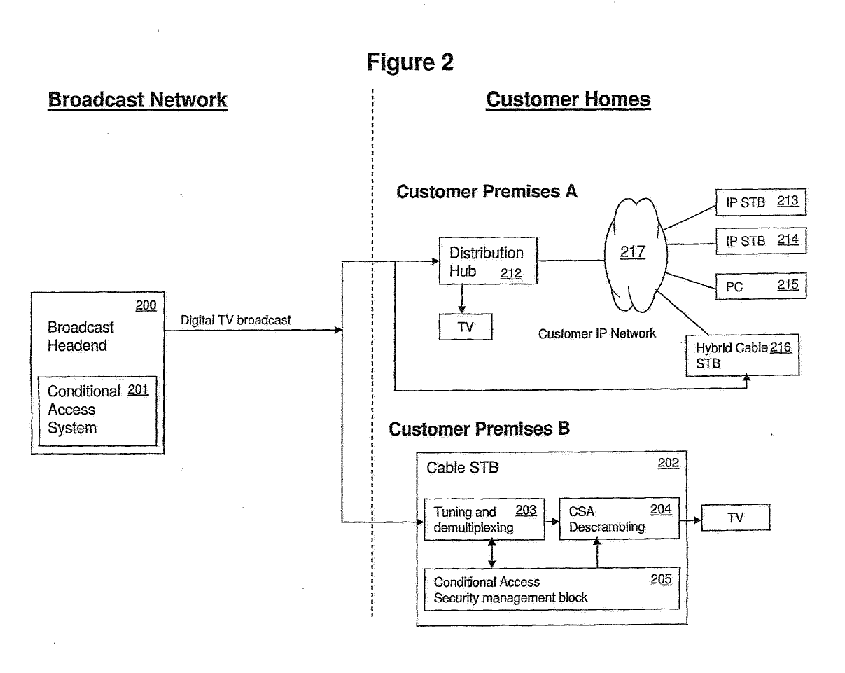

Turning to FIG. 2, in accordance with a further embodiment of the invention the DVB-CSA signal is received directly at a distribution hub 212 which is connected to the user's IP network 217. As will be described with reference to FIG. 3, the distribution hub 212 interacts with the various devices 213-216 on the IP network to enable respective devices to individually access, select and view various services independently of each other. As will be described, a feature of the invention is the facility to take a DVB signal which is fundamentally incompatible with IP networks and deliver it over an IP network to a plurality of network devices. In contrast to the previous embodiment, in this embodiment the operations required to convert the received digital TV services to be transmitted to a TV for display are performed within the distribution hub 212 in a similar manner to that described above with reference to the standard set top box 102 in FIG. 1. In this embodiment, the various devices connected to the IP network 217 includes a hybrid cable set top box 216 which can receive the digital TV services through the broadcast media and in addition receive some information over the IP network 217. Such hybrid cable set top boxes are well known in the art.

Turning now to FIG. 3, in accordance with a further embodiment of this invention, the distribution hub 312 receives the digital TV signal transmitted by the head-end broadcaster 100 and is able to tune to a selected scrambled service using the tuning and demultiplexing block. The distribution hub 312 comprises a CA security management block 303 to decrypt, where entitled, the ECMs corresponding to the selected service and a CSA descrambling block 304 to descramble the select service using a code word provided by the CA security management block 303. These actions are performed in a manner similar to that described with reference to the typical set top box 102 in FIG. 1. One of the purposes of the distribution hub 112 is to distribute services, on demand, across the IP network 117 to the various devices 113-115 connected thereto.

The Tuning and demultiplexing block 301 consists of one or more sets of tuners, demodulators and de-multiplexer units. Each of the tuners can tune to a single service at a time, enabling respective IP devices to request different services simultaneously. Intelligent control is required to facilitate simultaneous requests for different services, which is provided by the Tuning and Demultiplexing Management block 302. The Tuning and Demultiplexing Management block 302 also provides over the IP network 117 an indication of the services available through the received digital TV signal to enable the various devices 113-116 connected to the IP network 117 to select from the services.

In known DVB broadcast systems, information about available services (Program Specific Information (PSI) and Service Information (SI) which aids navigation across services) is conveyed in standard sets of tables included in the digital TV signal. At installation time, the Tuning and Demultiplexing Management block 302 scans for all available services in the received digital TV signal and analyses the PSI/SI data in each in order to compile a database of available services (in the normal manner in which a DVB or ATSC STB performs this function). In other embodiments, the Tuning and Demultiplexing Management block 302 may scan for all available services periodically or in response to a request received through the network. In the present embodiment of this invention, the Tuning and Demultiplexing management block 302 continually extracts the PSI and SI information from the received digital TV signal in order to provide an indication of the available services on the IP network 117. In the present embodiment the indication will include one or more IP addresses corresponding to where one or more services can be found.

When an IP receiver selects a service from those which are indicated to be available, it transmits a request to the distribution hub 112, across the IP network 117, using IP protocol. This request could be made by communicating the service number extracted from the PSI or SI information (in which case the invention could reply with the IP address where the service will be transmitted), or by communicating the IP address included in the indication (e.g., using an IGMP multicast join request).

On receiving the request, the Tuning and Demultiplexing block 302 configures an available tuner to receive the selected service. The selected service is forwarded to the CSA descrambling block to be descrambled.

The CSA descrambling block requires streams of code words (descrambling keys) in order to descramble the selected service received from the Tuning and Demultiplexing block 301. The descrambling is performed as in typical DVB-CSA systems, which will now be summarised.

The Conditional Access Security Management block 303 receives ECMs corresponding to the services included in the received digital TV signal. The ECMs which were inserted into the digital TV signal at the head-end broadcaster 100 are extracted from the signal by the Tuning and demultiplexing block 301. The ECM corresponding to a selected service is passed to the Conditional Access Security Management block 303 to be decrypted. (In commercial implementations the method of securing the ECMs is proprietary to each Conditional Access Solution). The information in the ECM is compared with data stored in the Conditional Access Security Management block 303 to see if authorisation has been given to descramble the selected service.

If authorisation has been given, the code word retrieved through the decryption is forwarded to the CSA descrambling block 304 to descramble the service in real time. The ECMs are extracted and processed continually in order to provide the CSA descrambling block 304 with the required stream of code words. The CSA descrambling block 304 produces 188-byte packets of MPEG PES data corresponding to the selected service, which are transmitted to the AES Scrambling block 305.

In another embodiment, if authorisation has not been given the Conditional Access Security Management block 303 may transmit a request to the Conditional Access (CA) System 101 at the head-end broadcaster 100 for an EMM to grant entitlement to descramble the selected service.

Broadcasters generally require their Pay TV services to be secured right until the point of display. Therefore, the selected service must be in an encrypted format if it is to be transmitted over the network 117 shown in FIG. 1. The applicant has appreciated that it is not practicable to equip the various devices 113-116 on the IP network 117 with the dedicated hardware required to descramble DVB-CSA services. It is therefore desirable to encrypt the signal in a way that meets broadcasters' requirements for the services to be secured, but also in a way which allows the various devices 113-116 on the IP network 117 to be able to decrypt the service without requiring additional hardware.

To achieve such a solution, in the present embodiment of this invention the distribution hub 112 comprises an AES Scrambling block 305 that encrypts the descrambled DVB-CSA service using the well-known AES algorithm. In the present embodiment the AES encryption of selected services is performed by dedicated hardware, but in other embodiments the operation could be performed in software or alternative IP-compatible encryption algorithms such as 3DES may be used and implemented in hardware or software. The standard 128-bit AES algorithm encrypts data in groups of 16 bytes using a key of up to 128 bits in length. Keys will be produced by the Conditional Access Security Management block 303 and delivered to the AES Scrambling Block 305. In the present embodiment of this invention, the keys are generated at random; in other embodiments they could be derived from the code words with which the selected service was encrypted, with a secure key derivation function, e.g., a hash function. Keys are replaced by newly generated keys every ten seconds.

The AES Scrambling Block 305 encrypts the 188-byte packets of MPEG PES data received from the CSA descrambling block 304 using the keys provided by the Conditional Access Security Management block 303. The encrypted services are then supplied to the Stream and IP transport processing block 306 for distribution across the IP network 117.

The Stream and IP transport processing block 306 groups together multiple encrypted packets, seven in this embodiment, into an IP transport frame. The Conditional Access Security Management block 303 produces ECMs suitable to be transmitted over the IP network 117, IP-ECMs which correspond to keys supplied to the AES Scrambling Block 305. The IP-ECMs are supplied to the Stream and IP transport processing block 306. In an alternative embodiment the ECMs extracted from the received digital TV signal are used in place of the generated IP-ECMs. The AES encryption algorithm is a private (symmetric) key algorithm, so the same key is required for encryption and decryption. In this embodiment the keys produced by the Conditional Access Security Management block 303 are delivered over the network with the services which they encrypt. This is done in a secure fashion by including with the encrypted packets the ECMs corresponding to the encryption keys. The groups of packets then have relevant IP header (e.g. UDP) information added and are transmitted over the IP network 117 via an ethernet socket. The ECMs are included such that they are repeated in the IP network data transfer at intervals of one tenth of a second.

In order to decrypt the encrypted services transmitted over the IP network 117, the various devices 113-116 connected thereto must each include a Conditional Access client solution and an enablement for each required service. The Conditional Access Security management Block 303, this same block generates EMMs suitable to enable the various devices 113-116 to decrypt the required services where they are authorised to do so. In other embodiments, alternative conditional access systems could be implemented, e.g. using a key distribution method such as Diffie-Hellman key exchange; other alternatives will be appreciated by those skilled in the art.

1. A method of processing a digital television TV signal at a customer premises' system comprising the steps of:
receiving a digital TV signal over a digital TV broadcast medium;
converting packet data comprising said received digital TV signal to internet protocol IP data packets; and
transmitting said IP data packets to a customer premises' IP device or IP network;
wherein the received digital TV signal is encrypted using an IP compatible encryption algorithm prior to the step of the IP data packets being transmitted to a customer IP device or IP network.

2. The method of claim 1, wherein the received digital TV signal is encrypted using an IP compatible encryption algorithm prior to the step of the packet data comprising said digital TV signal being converted to IP data packets.

3. The method claim 1, wherein said customer premises' system receives said digital TV signal over said digital TV broadcast medium in an encrypted format, said digital TV signal having been encrypted using a digital TV encryption algorithm and said customer premises' system un-encrypts said digital TV signal using the digital TV encryption algorithm prior to the converting step.

4. The method of claim 1, wherein said IP compatible encryption algorithm is an AES algorithm.

5. The method of claim 3, wherein said digital TV encryption algorithm is a Common Scrambling Algorithm CSA.

6. A customer premises' apparatus for processing a digital television TV signal comprising:
means for receiving a digital TV signal over a digital TV broadcast medium;
means for converting packet data comprising said received digital TV signal to internet protocol IP data packets;
means for transmitting said IP data packets to a customer IP device or IP network; and
means for encrypting the received digital TV signal using an IP compatible encryption algorithm prior to the IP data packets being transmitted.

7. The apparatus of claim 6, wherein the encrypting means is configured to encrypt the received digital TV signal prior to the packet data comprising said digital TV signal being converted to IP data packets.

8. The apparatus of claim 6, further comprising means for un-encrypting said received digital TV signal where said received digital TV signal has been encrypted using a digital TV encryption algorithm prior to being broadcast over the broadcast medium, said means for un-encrypting said received digital TV signal using the digital TV encryption algorithm.

9. The apparatus of claim 8, wherein said un-encrypting means is operable to un-encrypt said received digital TV signal where said received digital TV signal has been encrypted using a Common Scrambling Algorithm CSA method.

10. The apparatus of claim 6, wherein said encrypting means is operable to encrypt the received digital TV signal using an AES algorithm.

11. A computer readable medium containing computer-executable instructions that, when performed by a processor, cause said processor to perform the steps of;
receiving a digital TV signal over a digital TV broadcast medium;
converting packet data comprising said received digital TV signal to internet protocol IP data packets; and
transmitting said IP data packets to a customer premises' IP device or IP network;
wherein the received digital TV signal is encrypted using an IP compatible encryption algorithm prior to the step of the IP data packets being transmitted to a customer IP device or IP network.
